(19) United States
(12) Patent Application Publication
(10) Pub. No.: US 2012/0192981 A1
(43) Pub. Date: Aug. 2, 2012

(54) LINING MEASUREMENT SYSTEM FOR A PIPE OR OTHER FLUID-HANDLING COMPONENT

(76) Inventor: Peter Kruchoski, Hibbing, MN (US)

(21) Appl. No.: 13/362,594

(22) Filed: Jan. 31, 2012

Related U.S. Application Data
(60) Provisional application No. 61/438,256, filed on Jan. 31, 2011.

(51) Int. Cl. F16L 55/10

(52) U.S. Cl. 138/89

(57) ABSTRACT

A fluid-handling component comprises a support element having a surface and an aperture extending through at least a portion of the support element and opening to the surface. The fluid-handling component further comprises a liner disposed on the surface of the support element and having a first liner surface facing away from the surface of the support element. The liner covers the aperture and has a back liner surface facing in a direction away from the first liner surface. A cover member is also secured to the support element and configured to cover the aperture, where the cover member has an inner surface that faces the back liner surface.

### CROSS-REFERENCE TO RELATED APPLICATION

The present application is based on and claims the benefit of U.S. provisional patent application Ser. No. 61/438,256, filed Jan. 31, 2011, the content of which is hereby incorporated by reference in its entirety.

### BACKGROUND

The discussion below is merely provided for general background information and is not intended to be used as an aid in determining the scope of the claimed subject matter.

Lining material, such as but not limited to, urethane, natural gum or synthetic rubber is provided inside pipes and other fluid handling components to protect the fluid-handling component and/or isolate the fluid-handling component from the fluid contained therein. In some applications, the thickness of the lining material on the fluid-handling component may be reduced simply due to use of the fluid-handling component. For instance, in one exemplary application, pipes are used to transport bitumen from oil sands, which can serve as energy resources because bitumen contains hydrocarbons. However, extraction of energy resources from oil sands imposes harsh demands on equipment.

Bitumen and any other mineral resources are typically extracted from the ground in slurry which includes a suspension of insoluble particles. The slurry can include hydrocarbons, water and particulate sand and rock material with particles up to four inches and greater in diameter. Although it is known to use a liner to protect the inside of the pipe from the particles, the thickness of the liner will reduce through use. To ascertain whether the pipe should be replaced, it is common practice to measure the thickness of the liner used inside the pipe. However, measuring the liner from the inside of the pipe requires that the pipe must be taken out of service and cleaned.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the Background.

A first aspect of the invention includes a fluid-handling component comprising a support element having a surface and an aperture extending through at least a portion of the support element and opening to the surface. The fluid-handling component further comprises a liner disposed on the surface of the support element and having a first liner surface facing away from the surface of the support element. The liner covers the aperture and has a back liner surface facing in a direction away from the first liner surface. A cover member is also secured to the support element and configured to cover the aperture, where the cover member has an inner surface that faces the back liner surface.

A second aspect of the invention includes a method comprising: providing a liner disposed on a surface of a support element of a fluid-handling component, wherein an aperture extends through at least a portion of the support element and opens to the surface and wherein the liner at least covers the aperture; and measuring a thickness of the liner from a back surface of the liner at least covering the aperture.

### BRIEF DESCRIPTION OF THE DRAWINGS

FIG. 1 shows a perspective view of a first embodiment of an assembly used to measure the thickness of a liner for a fluid-handling component.

FIG. 2 shows a top plan view of the assembly shown in FIG. 1.

FIG. 3 is a sectional view of the first embodiment taken along line 3-3 of FIG. 2.

FIG. 4 shows a perspective view of a second embodiment of an assembly used to measure the thickness of a liner for a fluid-handling component.

FIG. 5 shows a side elevational view of the assembly shown in FIG. 4.

FIG. 6 is a sectional view of the second embodiment taken along line 6-6 of FIG. 5.

FIG. 7 shows a perspective view of a third embodiment of an assembly used to measure the thickness of a liner for a fluid-handling component.

FIG. 8 shows a side elevational view of the assembly shown in FIG. 7.

FIG. 9 is a sectional view of the third embodiment taken along line 9-9 of FIG. 8 with parts removed.

### DETAILED DESCRIPTION OF ILLUSTRATIVE EMBODIMENTS

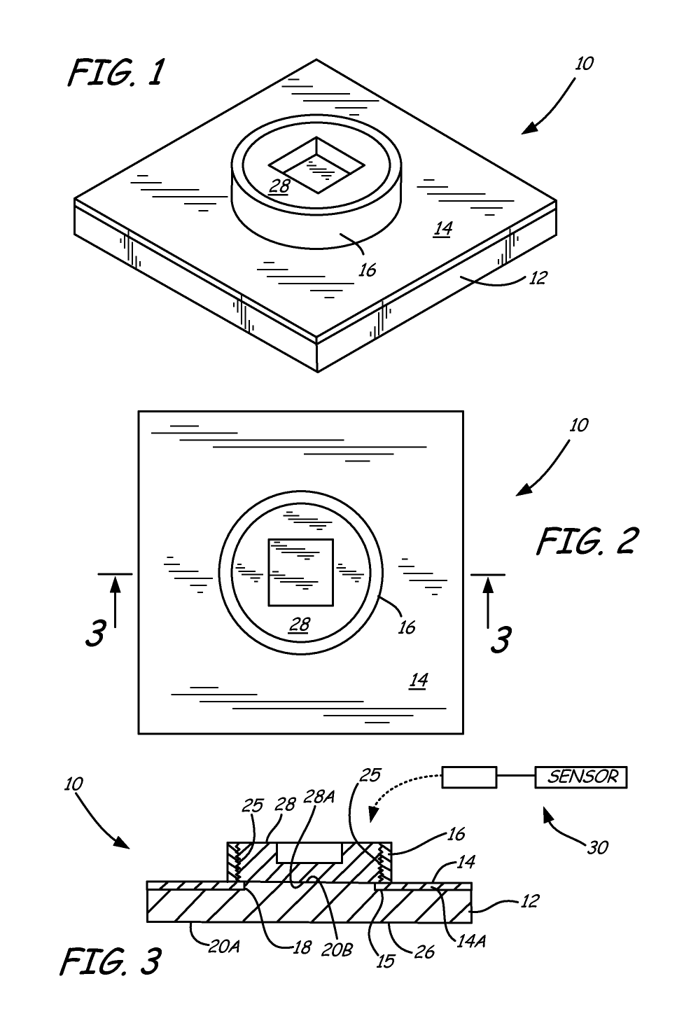

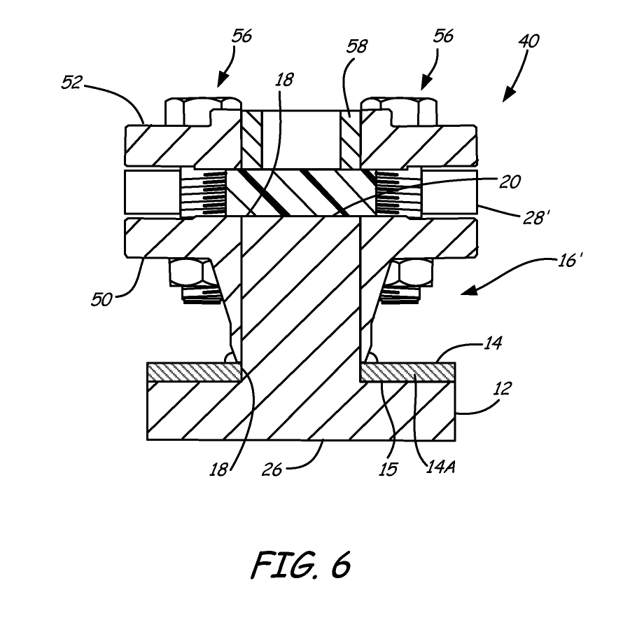

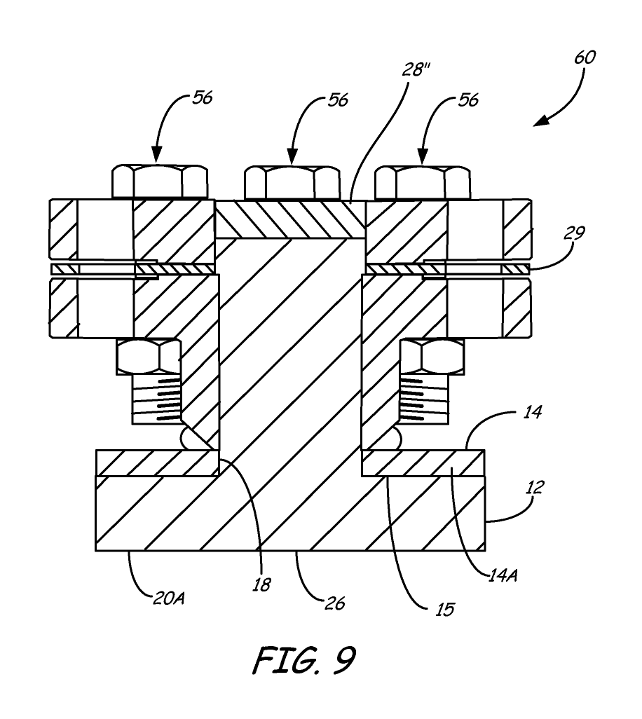

FIGS. 1-9 illustrate assemblies 10, 40 and 60 that can be used in order to measure the thickness of a liner 12 for a fluid handling component 14 (a portion of which is illustrated) such as but not limited to a pipe, a pump, a discharge assembly, etc.

Referring first to FIGS. 1-3, the assembly 10 comprises a support element 14A (a portion of the fluid-handling component 14, for example a portion of a pipe) having a surface 15 (inside surface of support element 14A) and providing an aperture 18 that extends through at least a portion of the support element 14A and opens to the surface 15. A liner 12 is disposed on the surface 15 of the support element 14A and has a first liner surface 20A that is exposed to the fluid and which faces away from the surface 15 of the support element 14A. The liner 12 at least covers the aperture 18 and has a back liner surface 20B, which faces in a direction away from the first liner surface 20A. A cover member 28 covers the aperture 18 and can be removed if desired. As illustrated in FIGS. 1 and 2, the cover member 28 is secured to the fluid handling component 14 and has an inner surface 28A which faces the back liner surface 20B. Herein a cylindrical support collar 16 having an inner bore is provided. In the embodiment illustrated, the support collar 16 and cover member 28 are both cylindrical. In particular, the support collar 16 can include threads 25 that threadably mate with threads provided on the cover member 28.

In one embodiment, the cover member 28 is made from a material such as steel and is removable so as to allow a suitable sensor such as an ultrasonic transducer based sensor, schematically illustrated at 30, to operably engage the back surface of the liner 12 to measure the thickness thereof so as to provide an estimate of the amount of liner 12 remaining. It should be noted that the thickness measurement can include liner material that extends into the aperture 18 as well as covering the aperature 18, such as illustrated, where a thickness measurement on the back surface 20B includes liner material equivalent to that of the thickness of the wall of the fluid handling component 14 or support element 14A.

It is important to note that the thickness of the liner 12 can be measured without removing the fluid material from the fluid handling component 14. However, if the cover member 28 is removed, this may entail taking the fluid handling component 14 out of service so as to reduce the pressure therein.

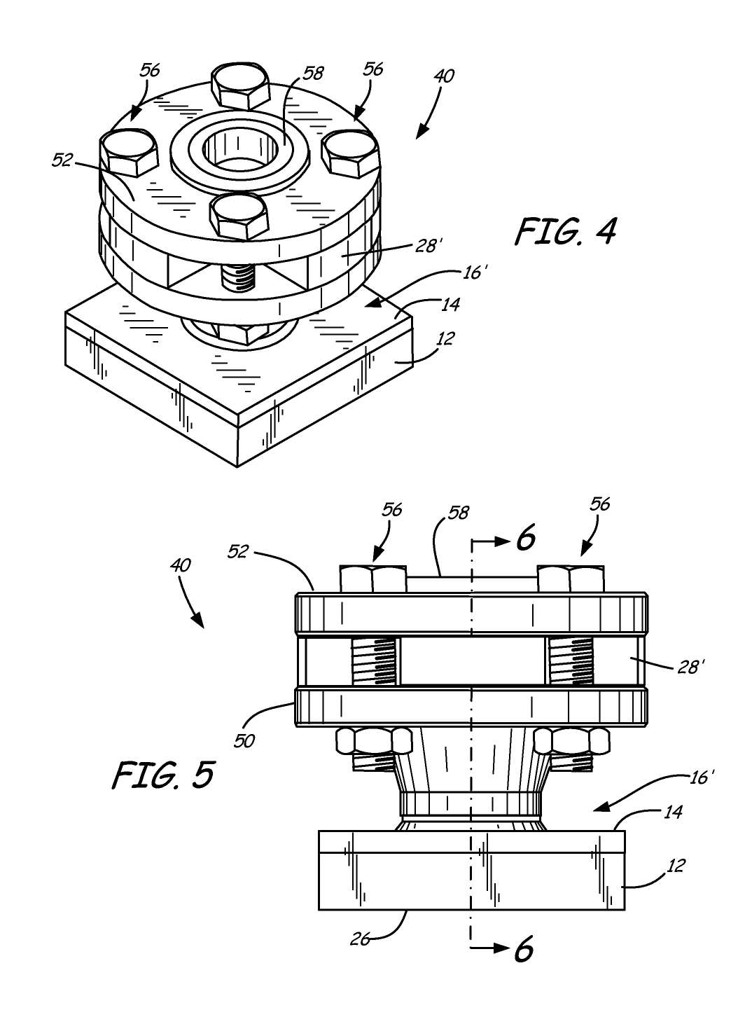

Referring next to FIGS. 4-6, assembly 40 also includes a support collar 16′ and a cover member 28′ which are configured to provide the functions as described above in the first embodiment. Although the cover member 28′ can be removed in order that the back liner surface 20B of the liner 12 can be accessed, in this embodiment, cover member 28′ is formed from a material that allows a measurement to be obtained therethrough. In this manner, it is possible to obtain a measurement and ascertain the thickness of the liner 12 covering the inner surface of the fluid handling component 14 (i.e., support element 14A such as adjacent to the aperture 18), while the fluid handling component 14 is still in service and commonly pressurized. In a particularly useful embodiment, the material used to form the cover member 28′ is of a type that, as far as the sensor 30 is concerned, is substantially similar to the material forming the liner 12. In the exemplary embodiment, the material of the cover member 28′ propagates sound waves substantially the same as the material comprising the liner 12. In one exemplary embodiment, the liner 12 can comprise urethane however it should be understood that the invention is not limited to urethane. For instance, in addition to urethane, the liner 12 can also be made of natural rubbers, synthetic rubbers, polymers as well as combinations of the foregoing along with other elements or compounds. The material forming the cover member 28′ can comprise but is not limited to glass, plexiglass, polymers, silica as well as combinations of the foregoing along with other elements or compounds.

At this point it should be noted that the cover member 28 of assembly 10 need not have to be removed in order to take a measurement. In other words there is no need to shut the line down. For instance, like the assembly 40, the cover member 28 can be formed from a material that allows a measurement to be obtained therethrough. Again, in the exemplary embodiment, the material of the cover member 28 can propagate sound waves at substantially the same speed as the speed through the liner 12. Although in further embodiments, the material comprising the cover member 28, 28′ (or 28″ discussed below) can be operably dissimilar to that of the liner 12 as long as the thickness of the liner 12 is ascertained with the required degree of confidence (i.e. accuracy and repeatability). As used herein, “operably dissimilar” is distinguished from “non-operably dissimilar” where the latter denotes a speed or propagation of sound through the cover member that is too different than that of the liner 12 such that accurate and repeatable measurements can not be obtained to ascertain the thickness of the liner 12. Whether similar or operably dissimilar materials are used for the liner 12 and cover member 28, 28′, 28″, a table of sonic measurements versus liner thickness can be created for different thicknesses of the liner and then used for subsequent measurements.

In assembly 40, cover member 28′ is held in place with opposed plate members 50 and 52. Plate member 52 can be considered a cap, which can also be made of steel or any of the materials discussed above with respect to cover member 28′. In the embodiment illustrated, plate member 50 is secured to support collar 16′ such as but not limited to being formed integral therewith from a single unitary body. However, in another embodiment, plate member 50 can be securely attached to support collar 16′ such as by welding. Fasteners 56 extend though apertures provided in plate members 50 and 52, and, if desired through cover member 28′. Fasteners 56 secure the plates 50 and 52 together and hence the cover member 28′ to the support collar 16′. Plate 52 can include an aperture 58 of size and shape to readily accept the transducer of the sensor 30. In both embodiments, the sensor 30 can be secured in place to take measurement repeatedly or the sensor 30 can be brought to any of the assemblies herein discussed when desired.

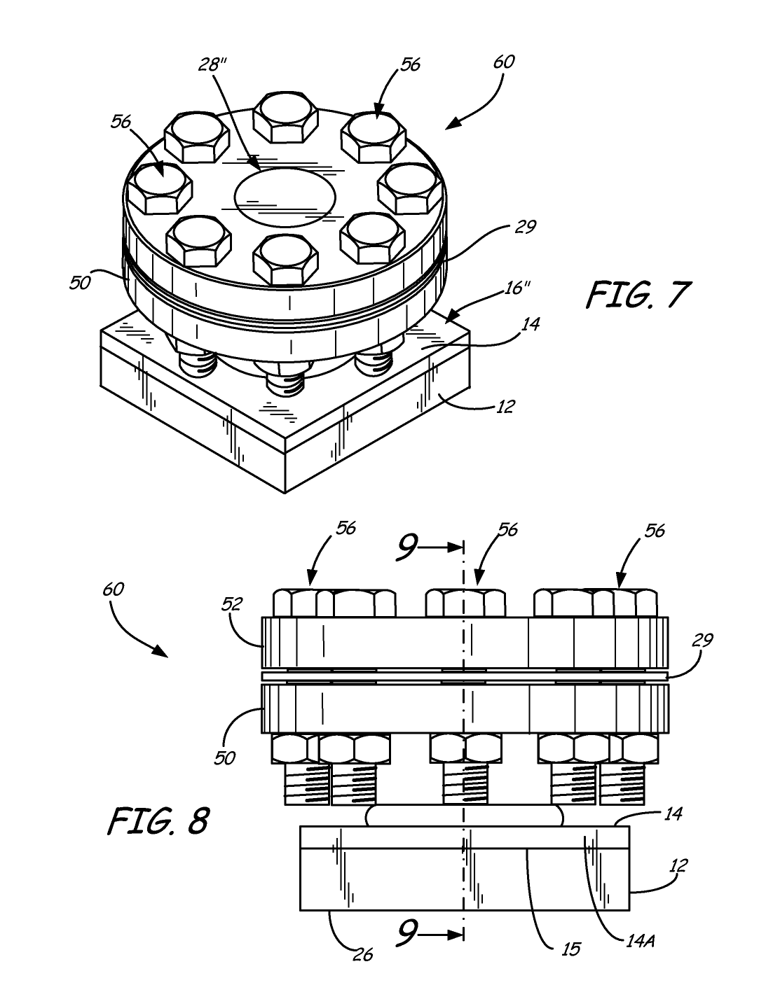

Referring next to FIGS. 7-9, assembly 60 also includes a support collar 16″ and a cover member 28″ which are configured to provide the functions as described above in the first and the second embodiment. In the embodiment illustrated, cover member 28″ is also formed from a material that allows a measurement to be obtained therethrough such that it is possible to obtain a measurement and ascertain the thickness of the liner 12 while the fluid handling component 14 is still in service and commonly pressurized. Any suitable adhesive material or bonding technique can be used to secure cover member 28″to the support collar 16″. In the embodiment illustrated, cover member 28″ is flush with the top surface 53 of plate member 52. In one embodiment, assembly 60 further includes a seal or gasket 29 disposed between plate members 50 and 52. As in the previous embodiment, a plurality of fasteners 56 extend though apertures provided in plate members 50 and 52, and secure the plates 50 and 52 together. In the embodiment illustrated, the composite cap is embedded into the flange.

In assemblies 40 and 60, the liner material 12 also extends within support collars 16′ and 16″ over a distance greater than that of assembly 10. In other words, the liner 12 covers the aperture 18, extends into the aperture 18 and extends into support collars 16′ and 16″. This may affect the type, strength or operating parameter of the sensor 30 used to ascertain the thickness. For example, a 1 megahertz ultrasonic sensor may be adequate to obtain a thickness measurement from assembly 10 where the sound is propagating only through the liner 12, while a ½ megahertz ultrasonic sensor may be needed for assemblies where the sound is being propagated through the cover member 28 and/or additional liner material 12 found in the support collars 16′ or 16″.

Assemblies 10, 40 and 60 can be included with the fluid handling component 14 when it is manufactured. If desired, assemblies 10, 40 and 60 can be provided on existing fluid handling components upon creation of aperture 18 and suitable fastening of the support collar 16, 16′, 16″ to the fluid handling component 14 such as by welding. Additional liner material 12 can be added if necessary in the bore of the support collar 16, 16′, 16″.

Although the subject matter has been described in language directed to specific environments, structural features and/or methodological acts, it is to be understood that the subject matter defined in the appended claims is not limited to the environments, specific features or acts described above as has been held by the courts. Rather, the environments, specific features and acts described above are disclosed as example forms of implementing the claims.

What is claimed is:

1. A fluid handling component comprising:
a support element having a surface and an aperture extending through at least a portion of the support element and opening to the surface;
a liner disposed on the surface of the support element and having a first liner surface facing away from the surface of the support element, the liner at least covering the aperture and having a back liner surface facing in a direction away from the first liner surface; and
a cover member secured to the support element and covering the aperture, the cover member having an inner surface facing the back liner surface.

2. The assembly of claim 1 wherein the liner and the cover member have similar sound propagation characteristics.

3. The assembly of claim 1 wherein the liner and the cover member have operably dissimilar sound propagation characteristics.

4. The assembly of claim 1 wherein the liner comprises urethane and the cover member comprises plexiglass.

5. The assembly of claim 1 wherein the support and the cover member threadably mate with each other.

6. The assembly of claim 1 wherein the support element comprises a support collar having a bore, the liner extending into the bore so as to have a thickness greater than portions of the liner adjacent the aperture.

7. The assembly of claim 6 wherein the cover member is provided in a cap and fasteners secure the cap to the support element.

8. The assembly of claim 1 wherein the support collar includes a plate to which the cap is secured.

9. A method comprising:
providing a liner disposed on a surface of a support element, wherein an aperture extends through at least a portion of the support element and opens to the surface and wherein the liner at least covers the aperture;
measuring a thickness of the liner from a back surface of the liner at least covering the aperture.

10. The method of claim 9 and further comprising removing a portion of the fluid handling component to gain access to the back surface of the liner.

11. The method of claim 9 wherein a cover member covers the back surface of the liner and wherein measuring comprises measuring through the cover member.

12. The method of claim 9 wherein a portion of the liner having the back surface is thicker than the portions of the liner secured to the surface adjacent the aperture.

13. The method of claim 9, wherein measuring the thickness of the liner includes measuring the thickness of the liner through the back surface.

14. The method of claim 9 wherein measuring includes measuring the thickness based on a sound wave transmission through the aperture.

15. The method of claim 14 wherein measuring includes measuring the thickness based on a sound wave transmission through the cover member.

16. The method of claim 9 wherein the liner and the cover member have similar sound propagation characteristics.

17. The method of claim 9 wherein the liner and the cover member have operably dissimilar sound propagation characteristics.
